(19) United States
(12) Patent Application Publication
(10) Pub. No.: US 2014/0034009 A1
(43) Pub. Date: Feb. 6, 2014

(54) Control Device for an Air Supply System and Method for Controlling or Regulating an Air Supply System

(71) Applicants: Stefan Brinkmann, Wunstorf (DE); Konrad Feyerabend, Hannover (DE)

(72) Inventors: Stefan Brinkmann, Wunstorf (DE); Konrad Feyerabend, Hannover (DE)

(73) Assignee: WABCO GmbH, Hannover (DE)

(21) Appl. No.: 14/112,292

(22) PCT Filed: Feb. 21, 2012
(86) PCT No.: PCT/EP2012/000739

§ 371 Date: Oct. 17, 2013

(30) Foreign Application Priority Data
May 5, 2011 (DE) 10 2011 100 512.2

(51) Int. Cl. F02D 45/00

(52) U.S. Cl. CPC F02D 45/00
USPC 123/319

(57) ABSTRACT

A control device for an air supply system of a vehicle, which has a transmission device and an internal combustion engine for driving the vehicle in load phases, is configured to receive measured pressure signals and to output control signals to initiate and terminate delivery phases of a compressor that is or can be connected to the internal combustion engine. The control device picks up state signals relating to a current state of the internal combustion engine and/or the transmission device and initiates a delivery phase as a function of the state signals in load phases of the internal combustion engine.

### FIELD OF THE INVENTION

The present invention generally relates to a control device for an air supply system and to a method for controlling or regulating an air supply system.

### BACKGROUND OF THE INVENTION

Air supply systems for compressed air systems in vehicles, especially trucks, generally comprise an air handling unit and a compressor connected to the air handling unit, which is directly driven by the internal combustion engine of the vehicle. For this purpose the compressor is directly connected via a gearbox or a belt to the engine shaft or can be decoupled from the engine shaft by a compressor clutch. The control of the air supply system takes place via a suitable control device, also known as an EAPU (electronic air processing unit), which switches between delivery phases, in which air is transported, and energy saving phases with low power consumption (power reduction mode). Switching can take place by controlling the compressor clutch, if one is provided, or by controlling suitable valves in the air handling unit or in the compressor. For this purpose, the control device generally receives pressure measurement signals of a pressure sensor, e.g., from one of the connected service brake circuits. If the pressure falls below a minimum pressure value, a delivery phase is initiated, which is terminated again on reaching an upper pressure value.

In load phases, the internal combustion engine drives the vehicle. In coasting phases, by contrast, the vehicle drives the coupled internal combustion engine; such coasting phases occur especially during downhill travel and braking processes without brake operation with the engine coupled (engine braking function). Here, it is known to preferably initiate a delivery phase of the compressor in coasting phases in order to use the available kinetic energy of the vehicle to drive the compressor. Delivery may thus take place in coasting phases of the internal combustion engine even if the measured pressure value in the service brake circuit does not require this, as long as a maximum allowable upper pressure value is not exceeded.

Newer generations of trucks enable the engine to be completely decoupled during coasting phases, i.e., an automatic transmission device is placed in an idling position in order to avoid engine braking. The vehicle is thus braked only by air resistance and rolling resistance, and the engine runs in idling mode at low revolution rate. The engine thereby typically consumes a great deal of fuel for the power generated, because it is far from the optimal operating point in the fuel consumption characteristic. Such idling phases or coasting phases can subsequently be terminated on the occurrence of limiting parameters such as detected excessive vehicle acceleration or an active operation by the driver in acting on the brake or gas pedal.

In such idling phases, coasting phase utilization of the compressor is thus not possible. Regulation may thus be purely pressure dependent, i.e., by measuring the pressure prevailing in the service brake circuit.

Furthermore, with conventional coasting phase utilization for air delivery in phases with high air consumption, pure coasting phase utilization is generally not sufficient for the generation of all the air required by the vehicle. The compressor is thus additionally operated in load phases of the internal combustion engine.

### SUMMARY OF THE INVENTION

Generally speaking, it is an object of the present invention to provide a control device and method for an air supply system that provide low energy consumption with full functionality.

According to embodiments of the present invention, a delivery phase of the compressor is initiated in load phases or a load mode of the internal combustion engine where possible, if favorable engine states are determined from the energy consumption. For this purpose, favorable characteristic curve areas can be detected in the fuel consumption characteristic of the internal combustion engine.

According to an embodiment, engine data are used for control or regulation of the delivery phases of the air supply system. It is thus possible to react especially to different energy consumptions per power used in the fuel consumption characteristic of the internal combustion engine.

Current data relating to the fuel consumption characteristic can always he communicated via a vehicle-internal data connection to the control device of the air supply system. Here, current data can be transferred in each case, e.g., depending on the respective air pressure and other external conditions. It is also possible that the fuel consumption characteristic is stored within or outside the control device, so that the control device of the air supply system can have access thereto.

Moreover, it is also possible, besides the fuel consumption characteristic of the engine, to also include the fuel consumption characteristic of the compressor. Depending on the revolution rate and the back pressure, each compressor has a specific power consumption per quantity of air delivered. From the superimposition of the consumption characteristics of the engine and of the compressor (for a known gear ratio between engine and compressor) a fuel consumption characteristic can be determined that gives the primary energy consumption per delivered quantity of air. The combined fuel consumption characteristic can be used for optimal regulation of the compressor control.

The control device of the compressed air system thus receives data related to an engine state, advantageously additionally also related to a gearbox state, such as e.g., the occurrence of an idling mode or coupling or decoupling. In principle, however, the occurrence of an idling mode or a coupled mode can also be determined from the engine data, because in the decoupled state or idling mode of the engine there is a lower revolution rate region with low engine load.

The control device of the compressed air system can thus initiate delivery phases if the additional power consumption of the compressor only causes relatively low additional fuel consumption.

Advantageously, by virtue of the present invention, the fuel consumption is relatively low. Furthermore, compressed air can be generated in advance when the energy demand of the engine per power supplied or per transported quantity is low, so that there is no additional load on the engine as a result of any delivery phases required in later load phases with high energy consumption per supplied power of the engine or per delivered air quantity.

According to an embodiment of the present invention, exclusion criteria can be additionally used in order to possibly suppress the initiation of the delivery phase despite detecting a favorable consumption characteristic area. The exclusion criteria can include the detection of a high load operation (e.g., gas pedal fully depressed), especially during uphill travel or travel under high load. Furthermore, as an exclusion criterion, it can be recognized that an acceleration or a high acceleration is desired, in order not to additionally load the engine by the compressor mode.

According to invention preferred embodiment, the entire pressure range, which is defined by the lowest pressure, below which the pressure in the system should not fall as the lower pressure threshold, and the highest pressure, which should not he exceeded in the system as the upper pressure threshold, is divided into several individual pressure regions, in which different control methods are operated. In a first, lower pressure region it is respectively provided, if the pressure falls below its lower pressure threshold, to supply compressed air until its upper pressure threshold is reached; a delivery phase is thus initiated in this case even in the event of possible poor conditions,

In a third, upper pressure region no delivery phase is started. On reaching or falling below its lower pressure threshold, a compressed air delivery can preferably be started if a coasting phase is recognized and is continued until its upper pressure threshold is reached or the coasting phase is terminated. This enables air delivery without additional energy consumption.

In a second, central pressure region, which can lie between the upper and lower pressure regions or can overlap them, a delivery phase can be initiated on falling below its lower pressure threshold and if favorable engine data are recognized, i.e., especially a favorable characteristic curve area in the fuel consumption characteristic, and if there are no exclusion criteria. The delivery phase is maintained until the favorable area in the engine characteristic is exited, or until the upper pressure threshold of the central pressure region is exceeded.

According to another embodiment, the control device can determine whether the coasting phases used in the third, upper pressure region are initiated at all, or whether the engine always or sometimes changes to an idling mode on reaching a coasting phase. 11f the latter, the upper pressure region can be omitted with the inventive arrangement, and the upper pressure threshold of the second, central pressure region can be placed so that delivery can be effected up to the highest pressure that may not be exceeded.

Upper and lower thresholds of the pressure regions, especially of the second pressure region, can be statically determined or preferably dynamically determined using the availability of sufficient coasting phases. If there are only a few coasting phases available, the upper pressure threshold can be raised. If there are very many coasting phases available, the lower pressure threshold of the second pressure region can be reduced to the lower pressure threshold of the first region.

Still other objects and advantages of the present invention will in part be obvious and will in part be apparent from the specification.

The present invention accordingly comprises the features of construction, combination of elements, arrangement of parts, and the various steps and the relation of one or more of such steps with respect to each of the others, all as exemplified in the constructions herein set forth, and the scope of the invention will be indicated in the claims.

### BRIEF DESCRIPTION OF THE DRAWINGS

The invention is explained in greater detail below using exemplary embodiments on the basis of the accompanying drawings, in which:

FIG. 1 shows a truck with its significant assemblies according to one embodiment of the invention;

FIG. 2 shows, in accordance with an embodiment of the present invention, a fuel consumption characteristic of the internal combustion engine;

FIG. 3 shows a division of the entire pressure region into several pressure regions according to an embodiment of the invention;

FIG. 4 is a flow diagram of a method according to an embodiment of the invention; and

FIG. 5 is, in accordance with an embodiment of the present invention, a diagram of the specific work demand depending on the compressor revolution rate.

### DETAILED DESCRIPTION OF THE PREFERRED EMBODIMENTS

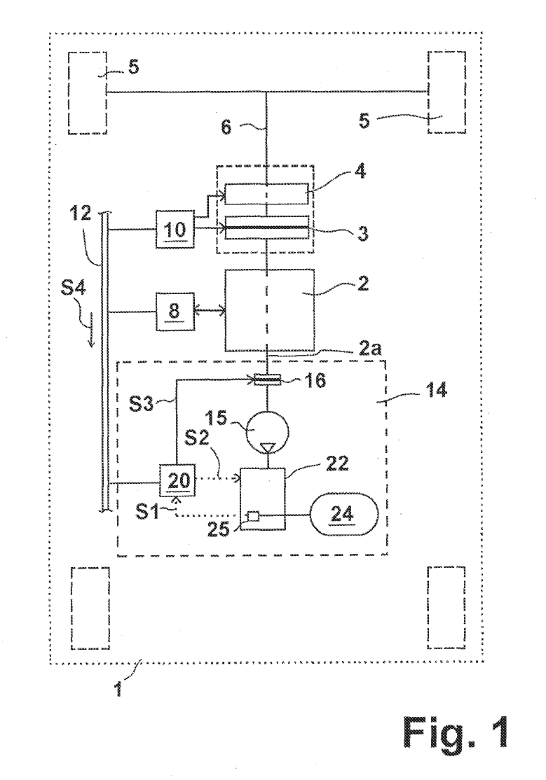

A truck 1 is illustrated in FIG. 1 with its relevant assemblies. The drive train essentially comprises an internal combustion engine 2 with an engine shaft 2a, a clutch 3, a gearbox 4 and an output shaft 6 leading to the driven wheels 5. The internal combustion engine 2 is controlled or regulated by means of an engine control device 8; accordingly, a transmission actuator 10 is provided for driving the clutch 3 and the gearbox 4. The clutch 3 and the gearbox 4 are in the form of an automatic gearbox or an automatic transmission device 3, 4 according to the embodiment. Accordingly, the transmission actuator 10 is an automatic transmission actuator 10. The transmission actuator 10 and the engine control device 8 are connected to a vehicle-internal data bus, in this case a CAN Bus 12.

An air supply system 14 essentially comprises a compressor 15 that is directly driven by the engine shaft 2a. A compressor clutch 16 is provided on the engine shaft 2a in order to decouple the compressor 15 from the engine shaft 2a from time to time; alternatively, an energy saving setting of the compressor can be provided so that it can idle from time to time without delivery power. The drive for the compressor clutch 16 takes place by means of a compressed air control device or EAPU (electronic air processing unit) 20, which is suitably connected to the CAN bus 12. Furthermore, the compressed air control device 20 controls valves of a pilot control valve device of an air handling unit 22 by means of valve control signals S2, in general a purge valve/discharge valve and a regeneration valve.

In a known manner, the air handling unit 22 comprises, besides the pilot control valve device, a filter, air dryers and a multi-circuit safety valve (not shown in detail). At least one consumer circuit 24 with a compressed air reservoir is connected to the air handling unit 22, e.g., a service brake circuit whose stored air pressure is measured by means of a pressure sensor 25 provided in the air handling unit 22, which outputs a pressure measurement signal S1 to the compressed air control device 20.

The compressed air-control device 20 is used in a known manner to establish different phases of the air supply system 14, wherein the compressed air control device 20 controls the compressor clutch 16 by means of compressor control signals S3 and controls the valve device by means of valve-control signals S2:

(i) a delivery phase in which the compressor 15 delivers air, for the embodiment shown with compressor clutch 16 engaged;

(ii) a rest phase in which the compressed air control device 20 disengages the compressor clutch 16 so that the compressor 15 does not deliver air; and

(iii) a regeneration phase in which likewise the compressor clutch 16 is disengaged, wherein the compressed air control device 20 outputs the valve control signals S2 to the individual valves of the valve device of the air handling unit 22 in order to initiate regeneration of the air dryer, which is not shown here in detail.

Still more phases may be provided.

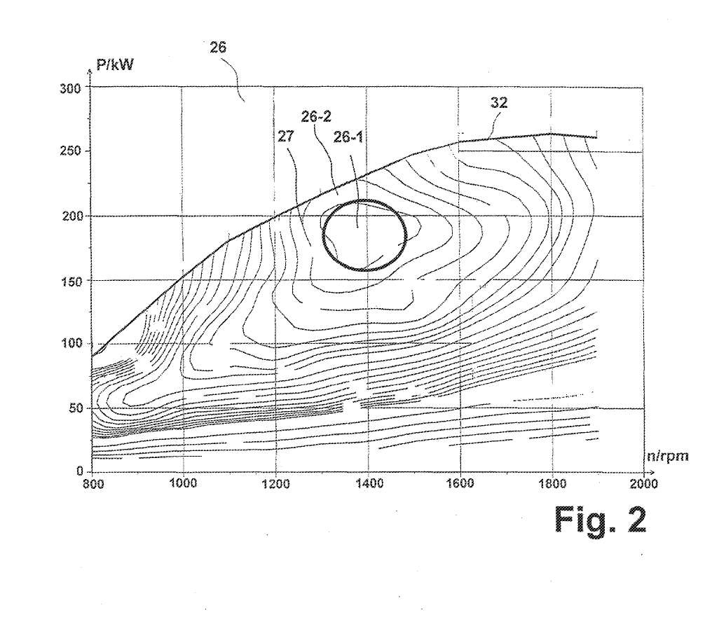

The engine control device 8 determines the respective current engine revolution rate n and engine power (engine load) P of the internal combustion engine 2, from which the fuel consumption characteristic 26 illustrated in FIG. 2 is composed, as is usual. Here, the engine revolution rate n in rpm is plotted on the abscissa (X axis) and the power P in kW is plotted on the ordinate (Y axis). The currently applied engine load n either be determined as an absolute value or relative (in %) to a. full load curve 32 shown in FIG. 2 and transmitted on the CAN bus 12.

Preferably, the engine control device 8 cooperates with the automatic transmission actuator 10 in order to select suitable areas in the fuel consumption characteristic 26 with low consumption, and to select corresponding advantageous settings on recognizing a higher revolution rate demand or higher acceleration demand.

The engine control device 8 can recognize load phases in which the internal combustion engine 2 has to provide significant power according to the ordinate (vertical axis of FIG. 2), so that there is a load phase in which the drive of the truck 1 takes place by means of the internal combustion engine 2. Furthermore, coasting phases can be recognized, in which, in the coupled state, the truck 1 drives the internal combustion engine 2 via the driven wheels 5, the output shaft 6, the gearbox 4 and the clutch 3 because of its kinetic energy. As is known, such coasting phases can especially occur during downhill travel and/or during braking processes. Instead of the engine control device 8, these determinations can also take place in another control or computing device with suitable functionality, e,g., a driving dynamics control system.

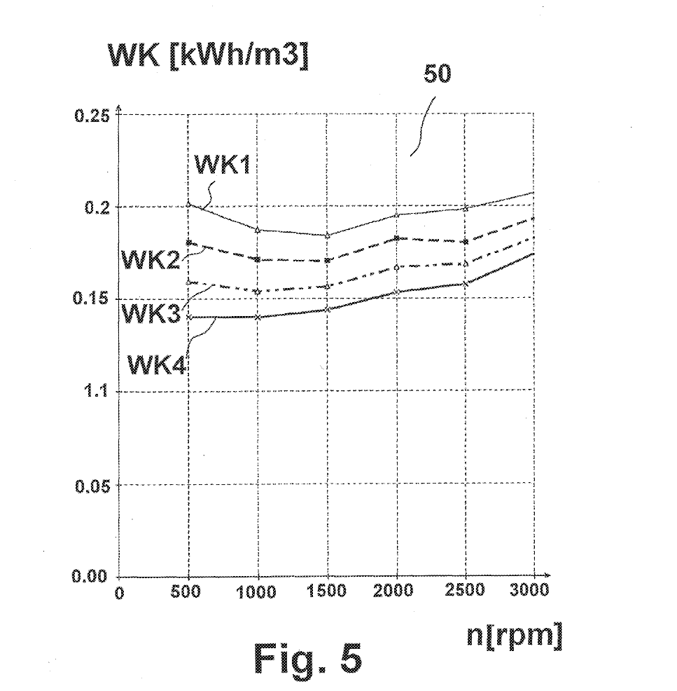

In addition, the compressor characteristic 50 shown in FIG. 5 can be included, which shows the specific work demand WK of the compressor with the dimension energy per delivered air volume, i.e., kWh/m³, depending on the compressor revolution rate, i.e., in the unit revolutions per minute. The curves indicate the following values:

WK1 at p=14 bar, WK2 at p=12 bar, WK3 at p=10 bar, WK4 at p=8 bar.

Because the compressor 15 is rigidly attached to the engine shaft 2a, the compressor revolution rate n and the engine revolution rate can be converted into a fixed, known transmission ratio; in the example shown, a direct drive with 1:1 ratio is assumed. Thus, a product of the values of FIGS. 2 and 5 can be formed, which can be used to assess the power consumption per delivered air quantity. A combined engine/compressor fuel consumption characteristic is thus given, which, compared to the purely engine fuel consumption characteristic 26, takes into account the compressor characteristic. The energy consumed per air quantity delivered (taking the pressure into account, i.e., therefore the air mass), is thus relevant

A fuel consumption characteristic will generally be discussed below, which can be the fuel consumption characteristic 26 or the combined fuel consumption characteristic.

The engine control device 8 or the control device provided for functionality can determine that decoupling and, thus, the establishment of idling is advantageous, whereby the truck 1 is thus no longer being braked by means of the internal combustion engine 2, but only by means of the dynamic resistances such as air resistance, rolling resistance, etc. The decoupling of the internal combustion engine 2 from the output shaft 6 can take place by operating the clutch 3 and/or establishing idling in the gearbox 4. The idling phase can then be terminated on recognizing suitable circumstances, e.g., in the event of brake operation or gas pedal operation by the driver (which is communicated by means of the CAN bus 12), or furthermore possibly in the event of a vehicle acceleration determined from the wheel revolution rates, or an excessive acceleration of the vehicle, e.g., because of a downhill gradient that is too large.

According to an embodiment of the present invention, the compressed air control device 20 receives state signals S4 via the CAN bus 12, e.g., engine state signals such as current revolution rate and current load and/or the current fuel consumption characteristic of the engine, driving state signals such as the current vehicle speed and the information as to whether there is currently a coasting phase or braking, or gearbox-signals such as the disengaged state of the clutch or another idling recognition means. Furthermore, the compressed air control device 20 has available data relating to the fuel consumption characteristic 26 or to the combined fuel consumption characteristic; advantageously the compressed air control device 20 has the entire fuel consumption characteristic 26 or the combined fuel consumption characteristic accessible. For this purpose, the fuel consumption characteristic 26 or the combined fuel consumption characteristic can be transmitted with the state signals S4, or the fuel consumption characteristic 26 or the combined fuel consumption characteristic is stored in the compressed air control device 20 or a connected external memory. The respective current position in the fuel consumption characteristic 26 or the combined fuel consumption characteristic is then taken into account by the compressed air control device 20 when establishing the different phases of the air supply system 14.

For establishing the delivery phases, the compressed air control device 20 thus uses the pressure-measurement signals S1 on the one hand and, on the other hand, the state signals S4 with data relating to engine revolution rate, engine power (engine load) or the position in the fuel consumption characteristic 26 or the combined fuel consumption characteristic and possibly an established idling mode.

The compressed air control device 20 initiates a delivery phase when it detects a low pressure value that could affect the functionality of the connected compressed air consumer, in each case by means of a suitable compressor control signal S3. Delivery phases are established in vehicle states in which the additional load by the compressor 15 leads to relatively little extra energy-consumption. Such states are shown in the fuel consumption characteristic 26 of FIG. 2 by engine characteristic curves 27 that represent areas with essentially identical fuel consumption per generated amount of energy. Thus, the characteristic curve area characterized by 26-1 is the area with the most favorable energy consumption, the energy consumption decreasing to each side so that, by contrast, the characteristic curve area 26-2 has a slightly greater energy consumption; the same applies in relation to the compressor characteristic 50 of FIG. 5.

The compressed air control device 20 can assign priorities to the individual characteristic curve areas 26-1, 26-2, . . . , so that the switch-on pressure value (cut-in), at which delivery starts, and/or the switch-off pressure value (cut-out) at which delivery is terminated, are specified depending on the priority.

By making the state signals S4 of the compressed air control device 20 continuously available via the CAN bus 12, a dynamic response can be made to changes in the characteristics 26, 50; such changes can be related to changes in the air pressure, e.g., a lower air pressure can relate to a greater height, so that the position in each fuel consumption characteristic and especially the arrangement of favorable characteristic curve areas 26-1, 26-2, . . . can change.

According to an embodiment of the invention, knowledge of overtaking processes and other high load operations can be included, so that in such high load operating phases of the internal combustion engine 2, all energy is available to the wheels 5; thus, preferably no compressed air is delivered in such high load phases, if this is not absolutely necessary because of a very low determined pressure value in the consumer circuit 24 or its compressed air reservoir.

Furthermore, knowledge of the idling mode can also be included. It can thus be provided that the compressed air control device 20 recognizes whether an engine braking function and, thus, coasting phases are provided, or whether an idling mode with decoupling is provided, and, depending on the determination, the upper and lower pressure thresholds are adjusted to initiate the delivery phases.

Furthermore, it can be determined whether a coasting mode with coupled internal combustion engine 2 is being used. If the use of such a coasting phase is determined, the compressor clutch 16 is engaged in the coasting phase in order to enable operation or the compressor 15. The information as to whether a coasting mode is subsequently established or not can be achieved via the CAN bus 12 by suitable state signals S4, i.e., especially state signals of the transmission actuator 10, and/or by automatic determination of the compressed air control device 20 or by self-learning.

According to an embodiment of the invention, the lower delivery compressed air value (cut-in) for initiating a delivery phase in load mode and the upper compressed air value (cut-out) for terminating a delivery phase in load mode can be dynamically adapted, depending on the air consumption and on the available coasting phases. The fewer coasting phases that are available—e.g. if there is a coasting function—and the less required air that can be correspondingly generated in the respective coasting phase, the higher can be the lower pressure threshold (switch-on pressure value, cut-in) according to the invention and also the upper pressure threshold (switch-off pressure value, cut-out), between which delivery can thus be carried out in optimal load phases. This ensures that the load phase mode is only active if there are not enough coasting phases available and thus load phases can be advantageously used if there are relatively few coasting phases.

According to a preferred embodiment, the following are used for operating the compressor 15 (delivery mode);

(a) preferably, coasting phase usage

(b) stable driving states (without high load modes, in which the compressor operation would be disturbed) with favorable characteristic curve areas 26-1, 26-2 are given lower priority, i.e., the load mode of the internal combustion engine 2 in these characteristic curve areas; and

(c) Only low priority idling modes and unfavorable load modes, i.e. high load operating phases such as acceleration phases and, e.g., travelling uphill.

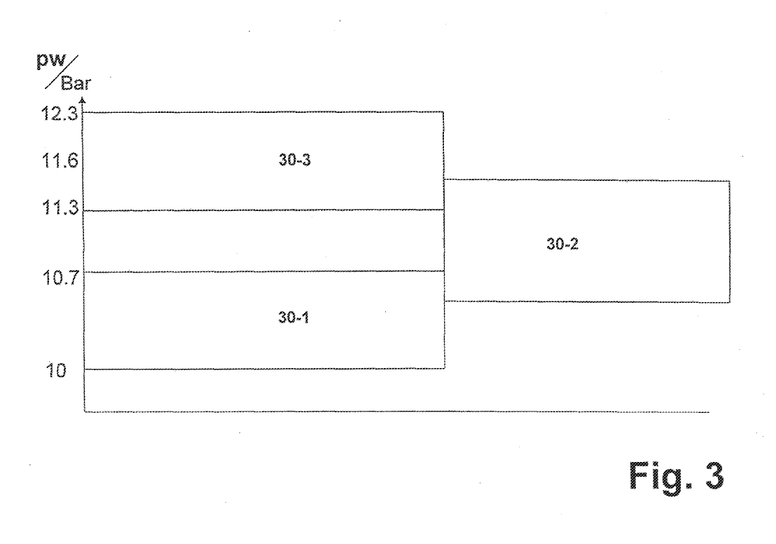

FIG. 3 shows an embodiment with an overall pressure range of the pressure value pw divided into individual pressure regions 30-1, 30-2 and 30-3 between, e.g., 10 bar and 12.3 bar, which can lead to different settings or regulation.

In a pressure region below 10 bar, in principle, a delivery mode is necessary; such a pressure value below 10 bar should not even occur here because delivery should already have taken place in the time in the above first lower pressure region 30-1. In first lower pressure region 30-1, delivery is carried out even under poor load conditions, i.e., in an unfavorable current position in the fuel consumption characteristic 26. For example, a lower pressure threshold of 10 bar can be specified here, at which switch-on occurs if the pressure falls below it, and an upper pressure threshold of 10.7 bar can be specified, at which switch-off occurs.

In the third, upper pressure region 30-3 of, e.g., 11.3 bar to 12.3 bar, only coasting phases of the internal combustion engine 2 are used for coupling the compressor 15 (delivery phase). Higher pressure values should not be reached, or no compressed air delivery takes place.

The boundaries of the second, central pressure region 30-2 can advantageously intersect with the boundaries of the first, lower pressure region 30-1 and third, upper pressure region 30-3 in order to prevent excessively frequent switching back and forth. In the second, central pressure region 30-2 on the one hand, coasting phases (coasting mode of the internal combustion engine 2) and, on the other hand, load phases of the internal combustion engine 2 with favorably assessed driving conditions, i.e., the presence of a favorable characteristic curve area 26-1, 26-2 and the absence of exception cases such as, e.g., high load mode, are used for delivery. The second, central pressure region 30-2 can, e.g., have a lower pressure threshold of 10.5 bar and an upper pressure threshold of, e.g., 11.5 bar.

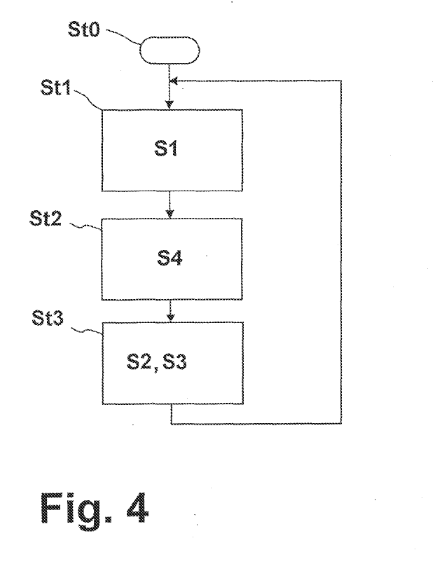

The method according to an embodiment of the invention thus starts according to FIG. 4 in step St0 with starting the internal combustion engine 2. According to a first step St1, pressure-measurement signals S1 are continuously recorded; according to a second step St2 state signals 84 of the engine control device and possibly of the transmission actuator 10 are continuously recorded. Steps 3t1 and St2 run substantially in parallel or sequentially here. In a third step St3, an assignment of the respective state to the three pressure regions of FIG. 3 is carried out, and control signals S2, S3 may be output depending on the assignment. Subsequently, the method is reset before the first step St1.

All of the above embodiments also apply when using a combined fuel consumption characteristic.

It will thus be seen that the objects set forth above, among those made apparent from the preceding description, are efficiently attained, and since certain changes may be made without departing from the spirit and scope of the invention, it is intended that all matter contained in the above description or shown in the accompanying drawings shall be interpreted as illustrative and not in a limiting sense.

It is also to be understood that the following claims are intended to cover all of the generic and specific features of the invention herein described and all statements of the scope of the invention that, as a matter of language, might be said to fall there-between.

What is claimed is:

1. A control device for an air supply system of a vehicle, the vehicle including a transmission device and an internal combustion engine for driving the vehicle in load phases, the control device being configured to (i) record pressure measurement signals and to output control signals for initiating delivery phases of a compressor that is connectable to the internal combustion engine, and (ii) record state signals about a current state of at least one of the internal combustion engine and the transmission device and to initiate a delivery phase depending on the state signals in load phases of the internal combustion engine.

2. The control device as claimed in claim 1, wherein the control device is configured to output the control signals for initiating a delivery phase in load phases of the internal combustion engine when characteristic values of at least one of the internal combustion engine and the compressor are in a characteristic curve region determined to be allowable based on the recorded pressure-measurement signals.

3. The control device as claimed in claim 2, wherein the characteristic curve region is defined by a combination of engine revolution rate and an engine power of the internal combustion engine.

4. The control device as claimed in claim 3, wherein the characteristic curve region includes a specific energy consumption of the compressor depending on one of delivered air volume and delivered air mass.

5. The control device as claimed in claim 1, wherein the control device is configured to (i) divide an overall pressure region of the pressure measurement signals into at least two pressure regions, (ii) one of initiate and maintain a delivery phase in a lower pressure region, independently of the recorded state signals, and (iii) in a second pressure region above the lower pressure region, initiate a delivery phase in one of the following states of the internal combustion engine: (a) a coasting phase in which the vehicle drives the internal combustion engine, and (b) a load phase in a favorable characteristic curve region when there is no exclusion criterion.

6. The control device as claimed in claim 1, wherein the control device is configured to (i) divide an overall pressure region of the pressure measurement signals into at least three pressure regions, and (ii) in an upper pressure region above a second pressure region, initiate a delivery phase only in a coasting phase of the internal combustion engine.

7. The control device as claimed in claim 6, wherein the second pressure region overlaps at least one of the upper pressure region and a lower pressure region.

8. The control device as claimed in claim 5, wherein the favorable characteristic curve region has relatively low fuel consumption per one of power, generated energy, and delivered air quantity.

9. The control device as claimed in claim 5, wherein a high pressure operating state is an exclusion criterion.

10. The control device as claimed in claim 1, wherein the control device is configured to automatically determine from the state signals whether decoupling of the internal combustion engine is effected from time to time to set up an idling mode in coasting phases, and based on said determination whether to output the control signals for initiating a delivery phase.

11. An air supply system, comprising: the control device as claimed in claim 1; an air handling unit having a valve device, the air handling unit being configured to be placed into different phases in response to the control signals of the control device, a delivery phase of the air supply system being initiable and terminable based on the control signals; and a pressure sensor configured to measure the pressure in a connected consumer circuit and to output the pressure-measurement signals to the control device.

12. A vehicle, comprising: the air supply system as claimed in claim 11; at least one connected service brake circuit; an internal combustion engine; an engine controller for controlling the internal combustion engine; an automatic transmission device for connecting the internal combustion engine to an output shaft for driving vehicle wheels; and an automatic transmission actuator for controlling the automatic transmission device, wherein the engine controller, the automatic transmission actuator and the control device of the air supply system are connected to each other via a vehicle-internal data bus.

13. A method for controlling the air supply system as claimed in claim 11, comprising: establishing and terminating delivery phases for delivering compressed air by the compressor; measuring air pressure provided by the air supply system; using the pressure measurement signals to control the delivery phases; and using the state signals to control the delivery phases.

14. The method as claimed in claim 13, further comprising: dividing an overall pressure region of the pressure measurement signal into at least two pressure regions; one of initiating and maintaining a delivery phase in a lower pressure region with low pressure values independently of the state signals; and, in a second pressure region above the lower pressure region, initiating a delivery phase when one of (i) a coasting phase of the internal combustion engine, in which the vehicle is driving the internal combustion engine, and (ii) a load phase of the internal combustion engine in a favorable characteristic curve region without an exclusion criterion is present.

15. The control device as claimed in claim 2, wherein the characteristic is a fuel consumption characteristic.

16. The control device as claimed in claim 9, wherein the high pressure operating state is one of the following states: uphill travel, acceleration, and acceleration above an acceleration threshold.

17. The method as claimed in claim 13, wherein the state signals relate to a relative position of characteristic values in a fuel consumption characteristic of at least one of the internal combustion engine and the compressor.
